(19) United States
(12) Patent Application Publication
(10) Pub. No.: US 2015/0339776 A1
(43) Pub. Date: Nov. 26, 2015

(54) FACILITY-INVESTMENT-SCENARIO PROVIDING DEVICE AND METHOD

(71) Applicant: HITACHI, LTD., Chiyoda-ku, Tokyo (JP)

(72) Inventors: Hisaya ISHIBASHI, Tokyo (JP); Masataka TANAKA, Tokyo (JP)

(21) Appl. No.: 14/758,351

(22) PCT Filed: Jan. 9, 2013
(86) PCT No.: PCT/JP2013/050241

§ 371 Date: Jun. 29, 2015

(51) Int. Cl. G06Q 40/06

(52) U.S. Cl. CPC G06Q 40/06

(57) ABSTRACT

To provide the information showing when the production facility is to be added or changed in order to obtain a larger income, a facility-investment-scenario providing device includes a facility-investment-scenario storage unit for storing a facility investment scenario having a facility investment pattern associated with each of periods obtained by dividing a total period for producing a product by every predetermined interval, and acquires the facility investment scenario corresponding to a selecting-input-received condition from the facility-investment-scenario storage unit and displays the facility investment pattern corresponding to each of the periods based on the acquired facility investment scenario.

### TECHNICAL FIELD

The present invention relates to a facility-investment-scenario providing device and method.

### BACKGROUND

Examples of background techniques of the present technical field include Japanese Patent Application Laid-Open No. 2004-280719 (Patent Document 1). This publication describes that “based on a rule database storing rules including selecting rules for selecting a step model corresponding to input step information and assignment rules for assigning the data included in the step information to the attribute possessed by the step model and a case database storing a plurality of step models expressed by connecting a plurality of members and sorted by attributes, a simulation model is generated by carrying out, in a model synthesis unit, a process of selecting the step model corresponding to the input step information and assigning the data included in the step information to the attribute possessed by the step model”.

### PRIOR ART DOCUMENT

### Patent Document

Patent Document 1: Japanese Patent Application Laid-Open No. 2004-280719

### SUMMARY

### Problems to be Solved by the Invention

The techniques described in Patent Document 1 cannot provide the information showing when a production facility is to be added or changed in order to obtain a larger income.

It is an object of the present invention to provide the information showing when the production facility is to be added or changed in order to obtain a larger income.

### Means for Solving the Problems

The typical ones of the inventions disclosed in the present application will be briefly described as follows.

According to an embodiment of the present invention, a facility-investment-scenario providing device includes a facility-investment-scenario storage unit for storing a facility investment scenario having a facility investment pattern associated with each of periods obtained by dividing a total period for producing a product by every predetermined interval, and a display unit for acquiring the facility investment scenario corresponding to a selecting-input-received condition from the facility-investment-scenario storage unit and displaying the facility investment pattern corresponding to each of the periods based on the acquired facility investment scenario.

Further, according to another embodiment of the present invention, a facility-investment-scenario providing method includes a display step of acquiring a facility investment scenario corresponding to a selecting-input-received condition by a display unit from a facility-investment-scenario storage unit and displaying a period and a facility investment pattern corresponding to the period by the display unit based on the acquired facility investment scenario.

### Effects of the Invention

According to an embodiment of the present invention, the information showing when the production facility should be added or changed in order to obtain the largest income can be provided.

### BRIEF DESCRIPTIONS OF DRAWINGS

FIG. 1 is a diagram showing an outline of a configuration example of a facility-investment-scenario providing device in a first embodiment of the present invention;

FIG. 2 is a diagram showing a configuration example of production-plan information stored in a production-plan storage unit according to the facility-investment-scenario providing device of FIG. 1;

FIG. 3 is a diagram showing a configuration example of a table stored in a step-information storage unit according to the facility-investment-scenario providing device of FIG. 1;

FIG. 4 is a diagram showing a configuration example of a table stored in a facility-information storage unit according to the facility-investment-scenario providing device of FIG. 1;

FIG. 5 is a diagram showing a configuration example of a table stored in a facility-investment-pattern storage unit according to the facility-investment-scenario providing device of FIG. 1;

FIG. 6 is a diagram showing a configuration example of a table stored in a production-base storage unit according to the facility-investment-scenario providing device of FIG. 1;

FIG. 7 is a diagram showing a configuration example of a table stored in a production-capacity-result storage unit according to the facility-investment-scenario providing device of FIG. 1;

FIG. 8 is a diagram showing a configuration example of a table stored in a facility-investment-scenario storage unit according to the facility-investment-scenario providing device of FIG. 1;

FIG. 9 is a diagram showing a configuration example of a table stored in a facility-investment-scenario-dependent-cost storage unit according to the facility-investment-scenario providing device of FIG. 1;

FIG. 10 is a diagram showing a configuration example of a table stored in a facility-investment-scenario-dependent-income storage unit according to the facility-investment-scenario providing device of FIG. 1;

FIG. 11 is a diagram showing a process flow of overall processing according to the facility-investment-scenario providing device of FIG. 1;

FIG. 12 is a diagram showing a process flow of a facility-investment-pattern generating process according to the facility-investment-scenario providing device of FIG. 1;

FIG. 13 is a diagram showing a process flow of a facility-investment-scenario generating process according to the facility-investment-scenario providing device of FIG. 1;

FIG. 14 is a diagram showing a process flow of an income calculating process according to the facility-investment-scenario providing device of FIG. 1;

FIG. 15 is a diagram showing a process flow of an income calculating process subsequent to FIG. 14;

FIG. 16 is a diagram showing an example of a facility-investment-scenario display screen according to the facility-investment-scenario providing device of FIG. 1;

FIG. 17 is a diagram showing an example of a period-dependent income display screen according to the facility-investment-scenario providing device of FIG. 1;

FIG. 18 is a diagram showing an example of a facility-investment-scenario/income display screen according to the facility-investment-scenario providing device of FIG. 1;

FIG. 19 is a diagram showing an example of a currency-variability-rate-scenario display screen according to the facility-investment-scenario providing device of FIG. 1;

FIG. 20 is a diagram showing an example of a demand-increase-rate/scenario display screen according to the facility-investment-scenario providing device of FIG. 1;

FIG. 21 is a diagram showing an example of a demand-increase-rate/price display screen according to the facility-investment-scenario providing device of FIG. 1;

FIG. 22 is a diagram showing an example of an entry screen according to the facility-investment-scenario providing device of FIG. 1; and

FIG. 23 is a diagram showing an example of a facility-information input screen according to the facility-investment-scenario providing device of FIG. 1.

### DETAILED DESCRIPTION

Hereinafter, embodiments of the present invention will be described in detail with reference to the accompanying drawings. Note that units having the same function are denoted by the same reference symbols throughout all drawings for describing the embodiments, and the repetitive description thereof will be omitted.

<System Configuration>

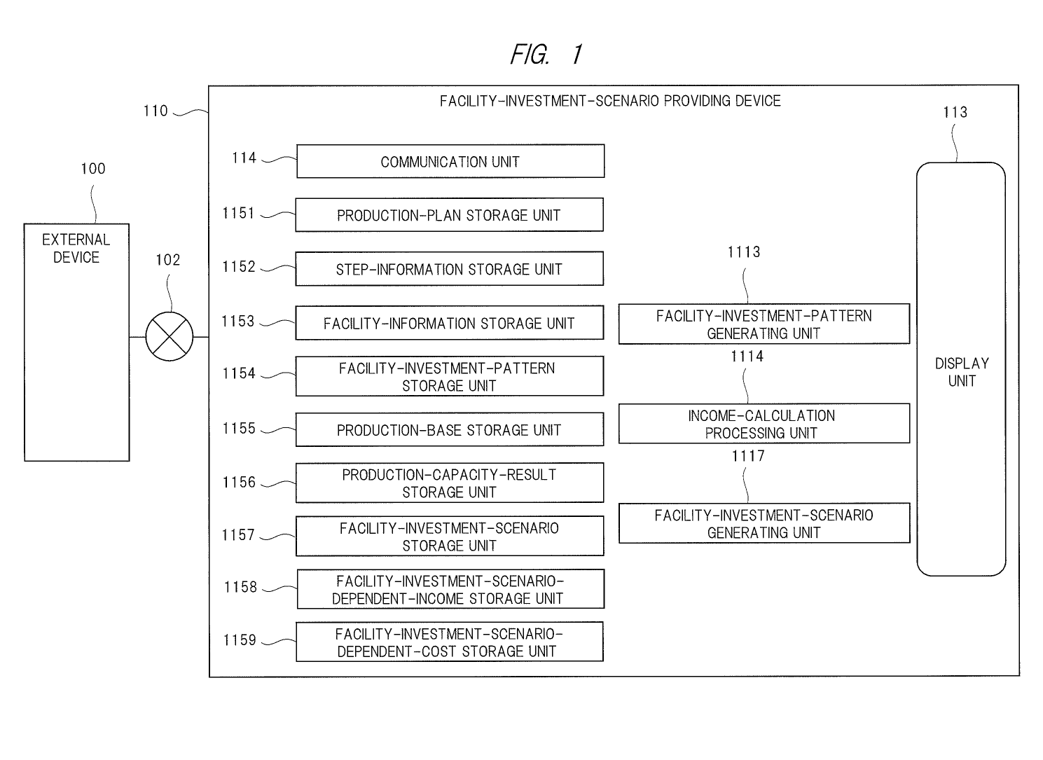

FIG. 1 is a diagram showing an outline of a configuration example of a facility-investment-scenario providing device 110 in a first embodiment of the present invention. In FIG. 1, the facility-investment-scenario providing device 110 is implemented by predetermined hardware and software. For example, the facility-investment-scenario providing device 110 has a processor, a memory, etc., and a computer of the facility-investment-scenario providing device 110 is caused to function by executing a program(s) in the memory by the processor.

The facility-investment-scenario providing device 110 has a display unit 113, a communication unit 114, a facility-investment-pattern generating unit 1113, an income-calculation processing unit 1114, a facility-investment-scenario generating unit 1117, a production-plan storage unit 1151, a step-information storage unit 1152, a facility-information storage unit 1153, a facility-investment-pattern storage unit 1154, a production-base storage unit 1155, a production-capacity-result storage unit 1156, a facility-investment-scenario storage unit 1157, a facility-investment-scenario-dependent-income storage unit 1158, and a facility-investment-scenario-dependent-cost storage unit 1159.

The facility-investment-pattern generating unit 1113 generates facility investment patterns storing the names of facilities operated in respective steps. Then, the facility-investment-pattern generating unit 1113 stores the generated facility investment patterns in the facility-investment-pattern storage unit 1154. Furthermore, the facility-investment-pattern generating unit 1113 calculates the number of producible products for each of the facility investment patterns. Then, the facility-investment-pattern generating unit 1113 stores production capacity results, in which the calculated numbers of producible products, the facility investment patterns, and products are associated, in the production-capacity-result storage unit 1156.

The facility-investment-scenario generating unit 1117 generates facility investment scenarios associated with the facility investment patterns in respective periods, which are obtained by dividing a total period for producing products based on a production plan by every predetermined interval. Then, the facility-investment-scenario generating unit 1117 stores the generated facility investment scenarios in the facility-invest-scenario storage unit 1157.

The income-calculation processing unit 1114 calculates the incomes in the respective periods of the facility investment scenarios. Moreover, the income-calculation processing unit 1114 calculates the cost in the respective periods of the facility investment scenarios. Furthermore, the income-calculation processing unit 1114 calculates a total income by totalizing the incomes calculated for the respective periods. Moreover, the income-calculation processing unit 1114 calculates total cost by totalizing the cost calculated for the respective periods. Furthermore, the income-calculation processing unit 1114 associates the calculated incomes in the respective periods with the total period and stores them in the facility-investment-scenario-dependent-income storage unit 1158. Moreover, the income-calculation processing unit 1114 associates the calculated cost in the respective periods with the total cost and stores them in the facility-investment-scenario-dependent-cost storage unit 1159.

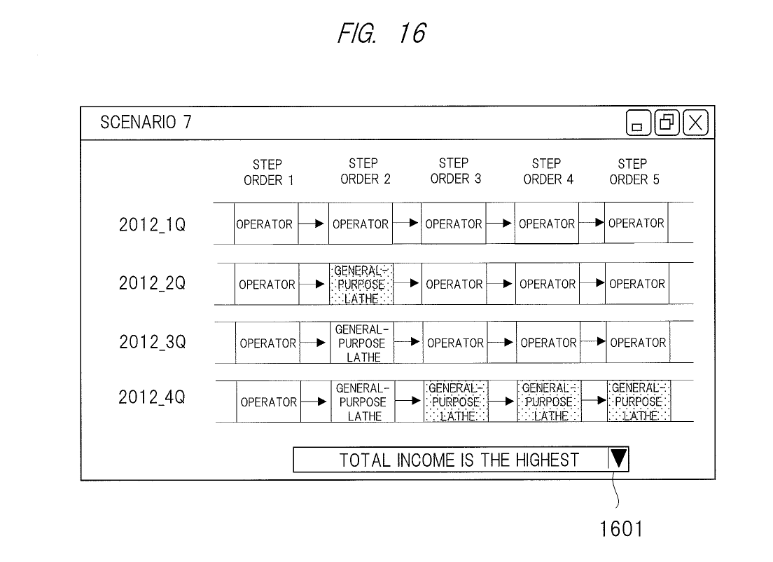

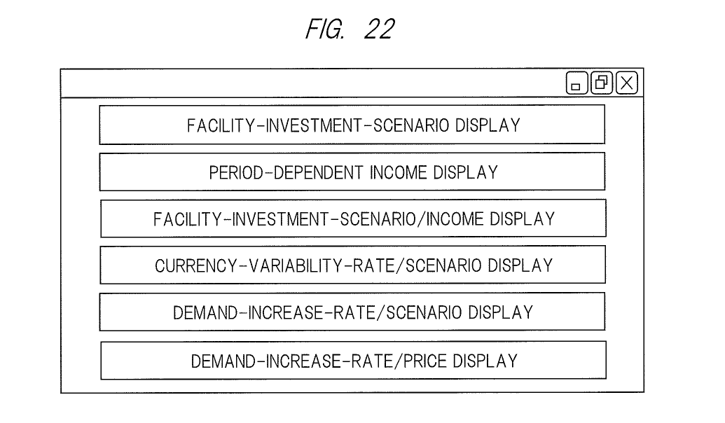

The display unit 113 acquires the facility investment scenario corresponding to set conditions from the facility-investment-scenario-dependent-income storage unit 1158 and displays a facility-investment-scenario display screen of FIG. 16. Moreover, the display unit 113 displays an entry screen (described later, FIG. 22). Then, when an input of selecting an item is received from the entry screen, the display unit 113 displays a corresponding screen.

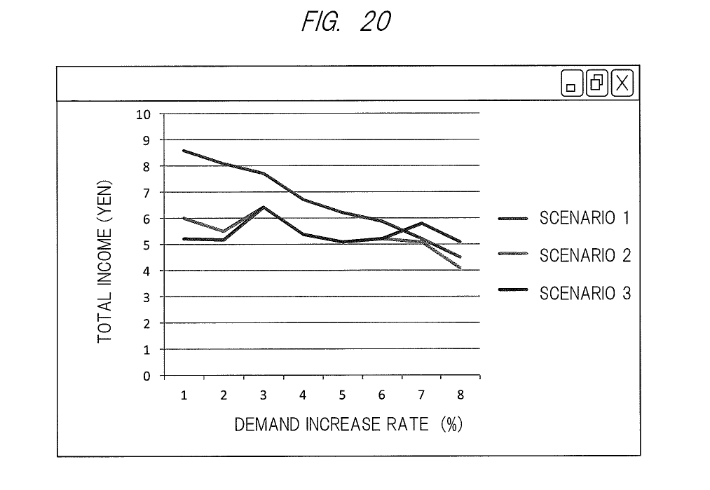

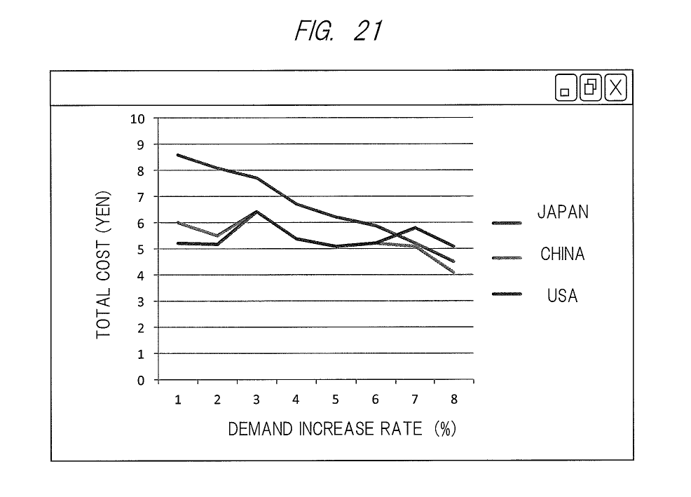

Furthermore, the display unit 113 displays a currency-variability-rate/scenario display screen (described later, FIG. 19), a demand-increase-rate/scenario display screen (described later, FIG. 20), or a demand-increase-rate/price display screen (described later, FIG. 21) based on the information received by the communication unit 114 from an external device 100 via a network 102 and the information acquired from facility-investment-scenario-dependent-income storage unit 1158.

<Table Configuration>

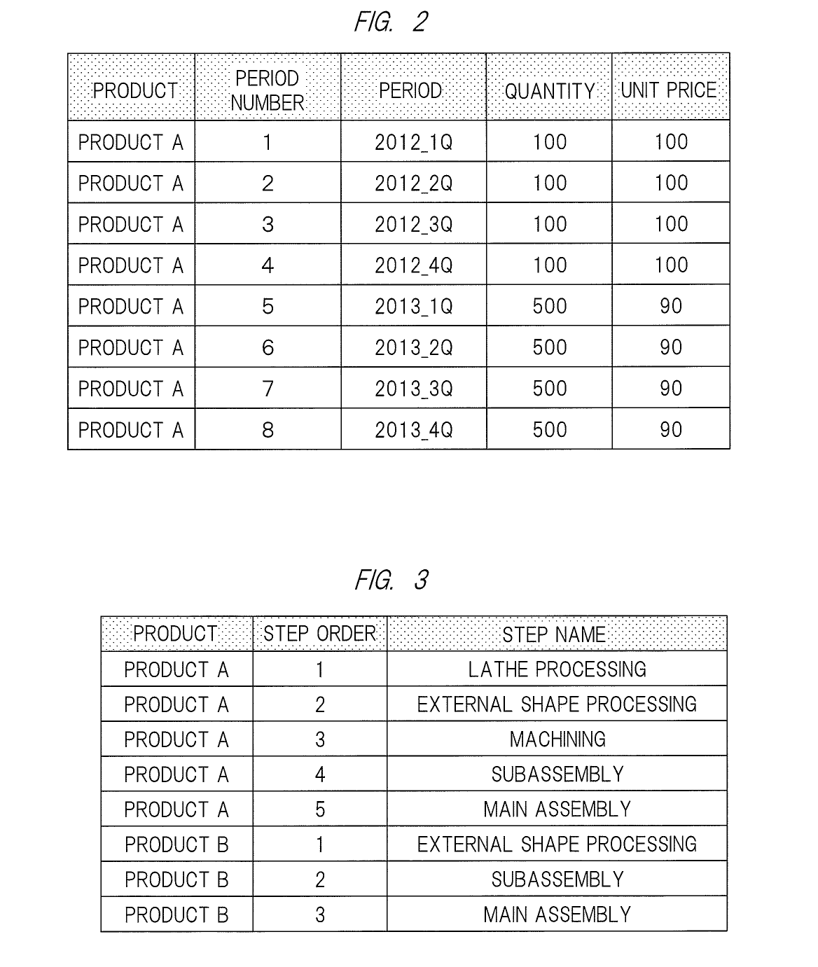

FIG. 2 is a diagram showing a configuration example of production-plan information stored in the production-plan storage unit 1151. The production-plan storage unit 1151 stores the production-plan information consisting of data items such as [products], [period numbers], [periods], [quantities], and [unit prices]. The [products] show information such as product names for identifying products. The [periods] show the periods in which the products are produced. The [periods] are obtained by dividing, by every predetermined interval, the total period for producing the products based on the production plan. The predetermined interval for dividing the total period for producing the products is one-day basis, one-week basis, one-month basis, quarter basis, one-year basis, or the like. The [period numbers] are the numbers allocated to the respective [periods]. If all of the corresponding [periods] are the periods of future compared with the present point of time (in other words, when the present device is used), the [period numbers] are allocated thereto in ascending order from the [period] nearest to the present point of time. The [quantities] show the planed values of the quantities for producing the products in the corresponding periods. The [unit prices] show the prices per each product when the products are sold.

FIG. 3 is a diagram showing a configuration example of step information stored in the step-information storage unit 1152. The step-information storage unit 1152 stores step information consisting of data items such as [products], [step orders], and [step names]. The [step orders] show the orders of steps. The [step names] show the names of the steps.

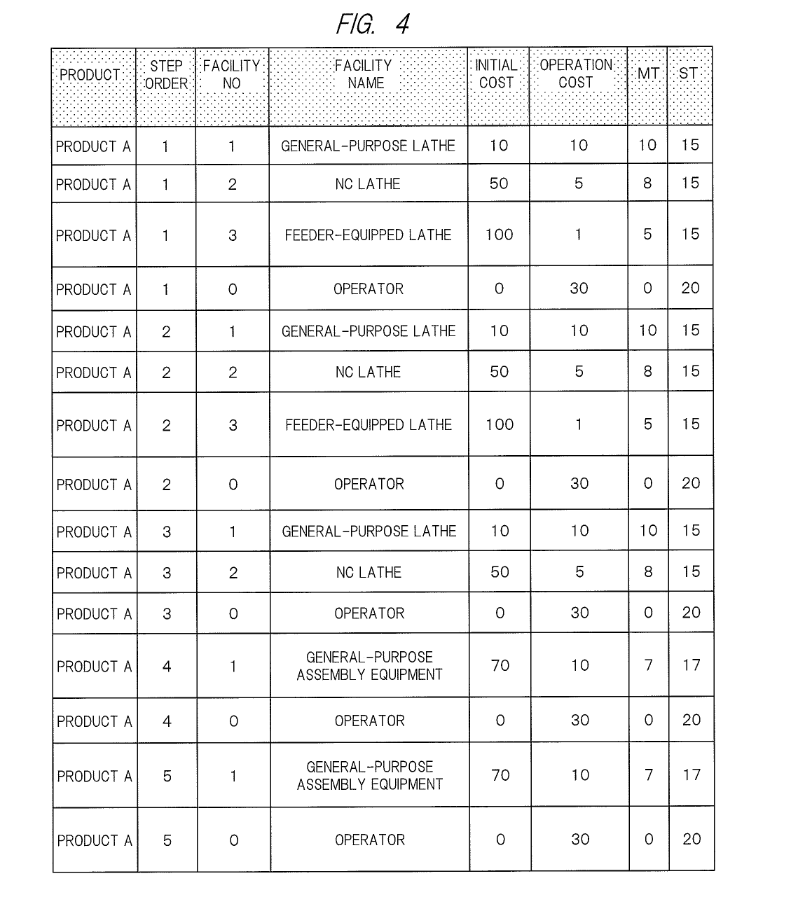

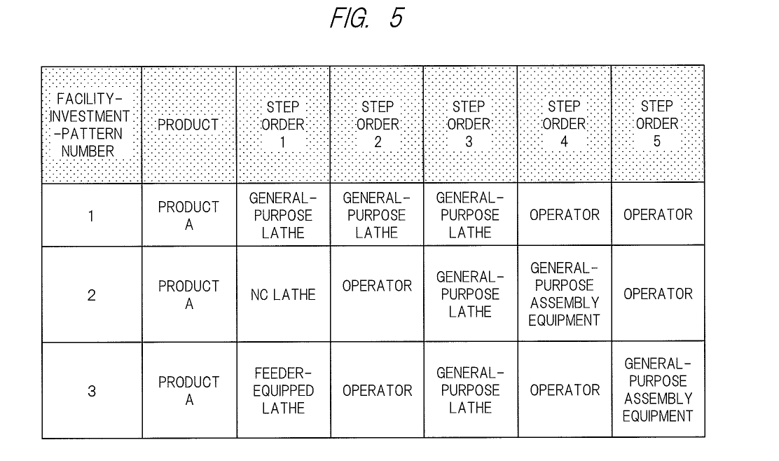

FIG. 4 is a diagram showing a configuration example of a table stored in the facility-information storage unit 1153. The table stored in the facility-information storage unit 1153 has data items such as [products], [step orders], [facility NO], [facility names], [initial cost], [operation cost], [MT], and [ST]. The [facility NO] shows the numbers for identifying facilities. The [initial cost] shows the cost required for installing and/or adding facilities. The [operation cost] shows the cost required for operating the facilities. [MT] shows the time required for processing steps by the facilities. [ST] shows the time required for processing the steps by an operator.

FIG. 5 is a diagram showing a configuration example of a table stored in the facility-investment-pattern storage unit 1154. The facility-investment-pattern storage unit 1154 stores the [products], facility investment patterns, and [facility-investment-pattern numbers] so that they are mutually associated. More specifically, the table stored in the facility-investment-pattern storage unit 1154 stores data items such as [facility-investment-pattern numbers], [products], [step order 1], [step order 2], [step order 3], [step order 4], and [step order 5]. The [facility-investment-pattern numbers] show the numbers for identifying the facility investment patterns. The facility investment pattern consists of data items such as [step order 1], [step order 2], [step order 3], [step order 4], and [step order 5] and store the names of the facilities corresponding to the respective step orders.

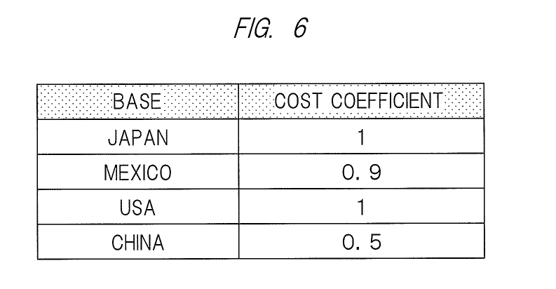

FIG. 6 is a diagram showing a configuration example of a table stored in the production-base storage unit 1155. The table stored in the production-base storage unit 1155 has data items such as [bases] and [cost coefficients]. The [bases] show the names of the places where the facilities are present. The [cost coefficients] show coefficients by which cost is multiplied.

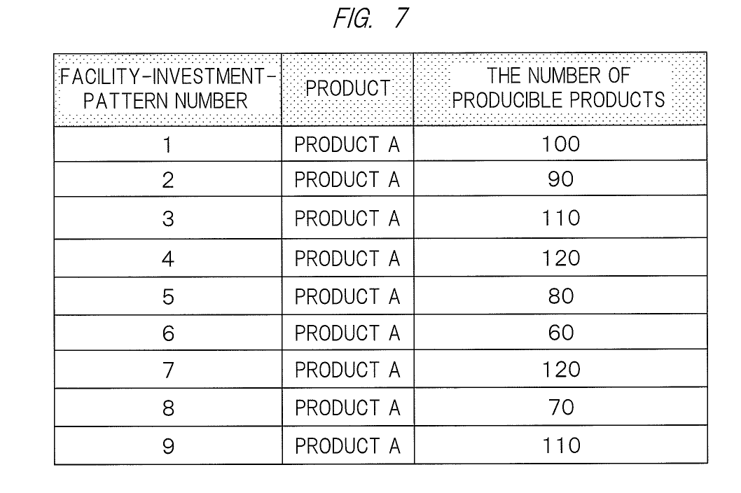

FIG. 7 is a diagram showing a configuration example of a table stored in the production-capacity-result storage unit 1156. The table stored in the production-capacity-result storage unit 1156 stores production capacity results consisting of data items such as [facility-investment-pattern numbers], [products], and [numbers of producible products]. The [number of producible products] shows the number of the products which can be produced in a quarter when a plant is operated by the facility investment pattern corresponding to the [facility-investment-pattern number].

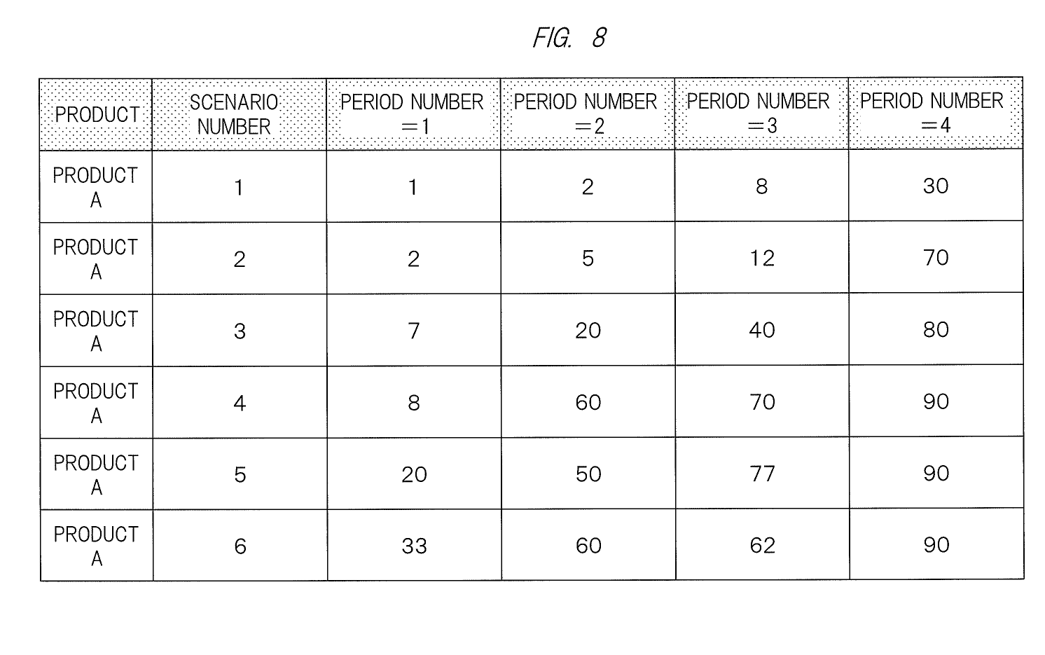

FIG. 8 is a diagram showing a configuration example of a table stored in the facility-investment-scenario storage unit 1157. The facility-investment-scenario storage unit 1157 stores facility investment scenarios, in which the facility investment patterns are associated with the respective periods obtained by dividing the total period for producing the products by every predetermined interval, in association with [scenario numbers]. More specifically, the facility investment scenario consists of data items such as [products] and [period numbers] and stores the facility-investment-pattern numbers of the facility investment patterns corresponding to the respective period numbers. The [scenario numbers] show the numbers for identifying the facility investment scenarios.

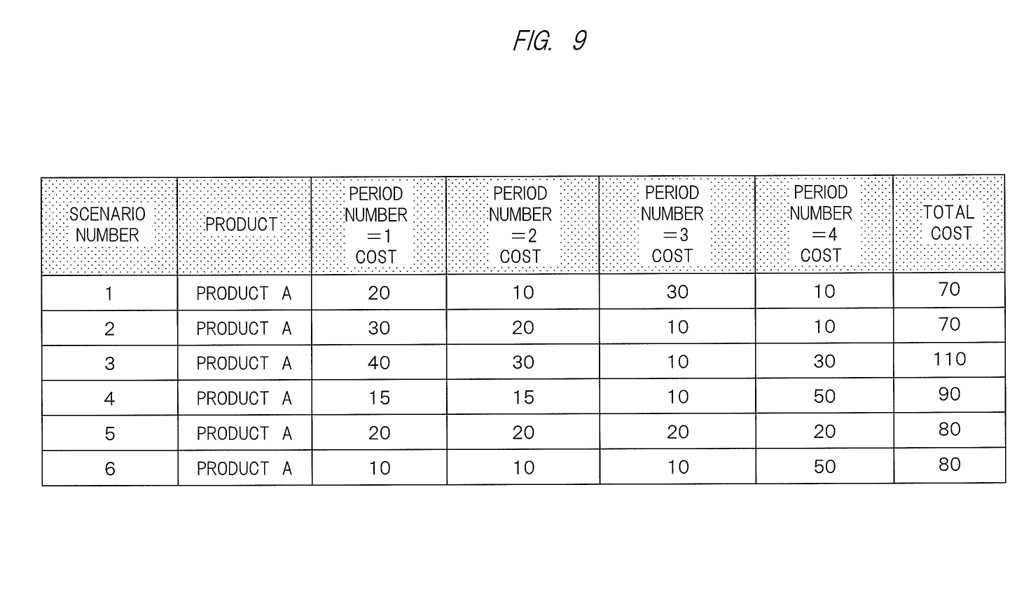

FIG. 9 is a diagram showing a configuration example of a table stored in the facility-investment-scenario-dependent-cost storage unit 1159. The table stored in the facility-investment-scenario-dependent-cost storage unit 1159 stores the [scenario numbers], the [products], the cost in the periods corresponding to the respective period numbers, and [total cost] so that they are mutually associated. The [total cost] stores the value obtained by totalizing the cost calculated for the periods.

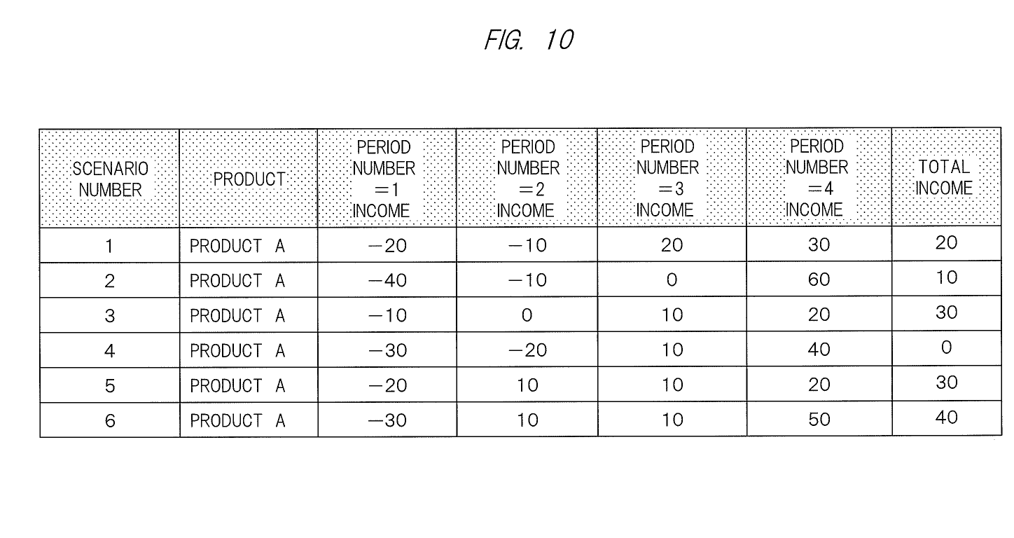

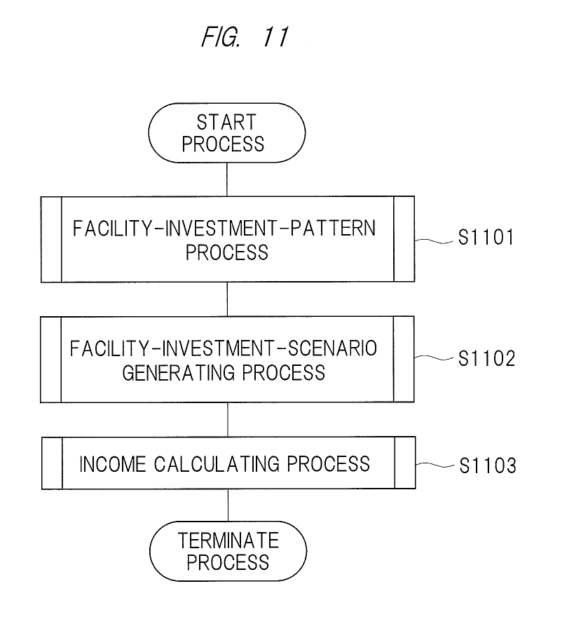

FIG. 10 is a diagram showing a configuration example of a table stored in the facility-investment-scenario-dependent-income storage unit 1158. The table stored in the facility-investment-scenario-dependent-income storage unit 1158 stores the [scenario numbers], the [products], the incomes in the periods corresponding to the respective period numbers, and [total income] so that they are mutually associated. The [total income] stores the value obtained by totalizing the incomes calculated for the periods.

<Overall Processing>

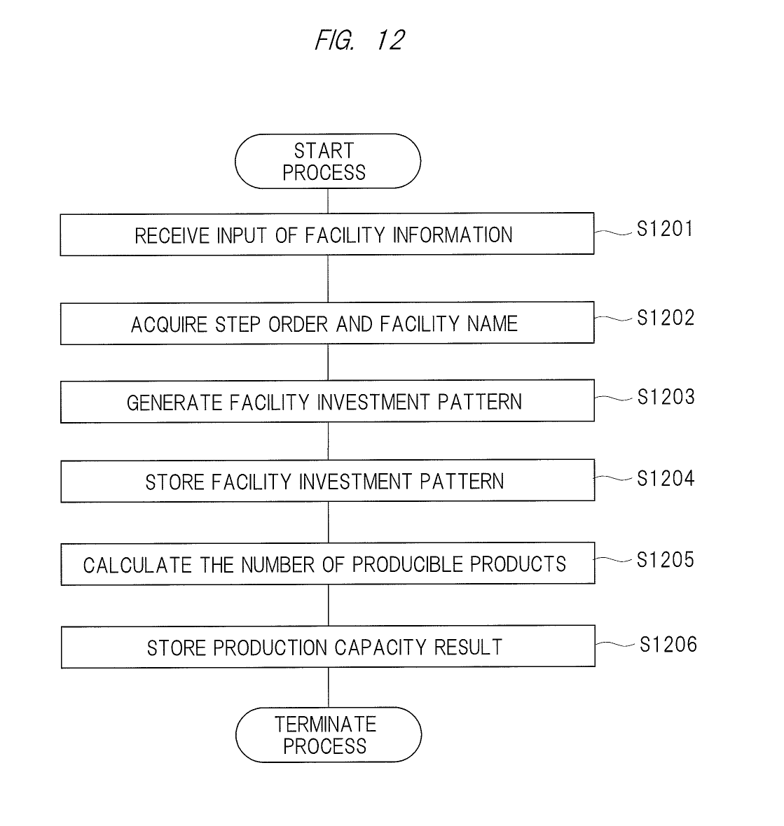

FIG. 11 is a diagram showing a process flow of overall processing of the present device.

First, in S1101, a facility-investment-pattern generating process (described later, FIG. 12) is carried out to generate facility investment patterns in which the names of the facilities operated in respective steps are stored. Then, after this process is terminated, the process proceeds to S1102.

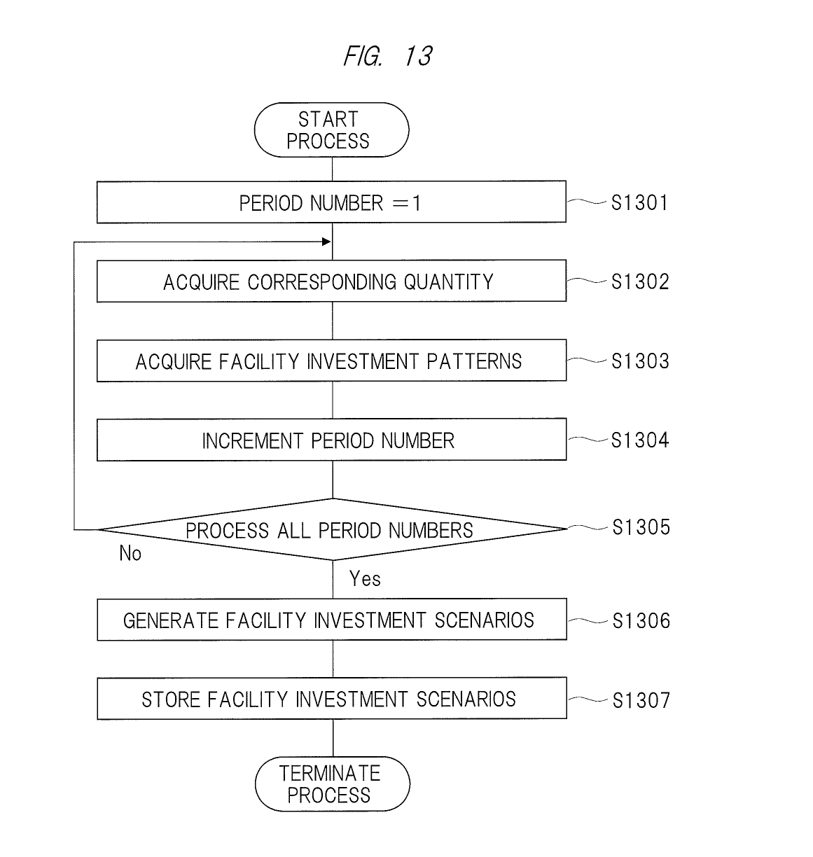

Then, in S1102, a facility-investment-scenario generating process (described later, FIG. 13) is carried out to generate facility investment scenarios in which the facility investment patterns generated in S1101 are associated with the respective periods, which are obtained by dividing the total period for producing the products by every predetermined interval. Then, after this process is terminated, the process proceeds to S1103.

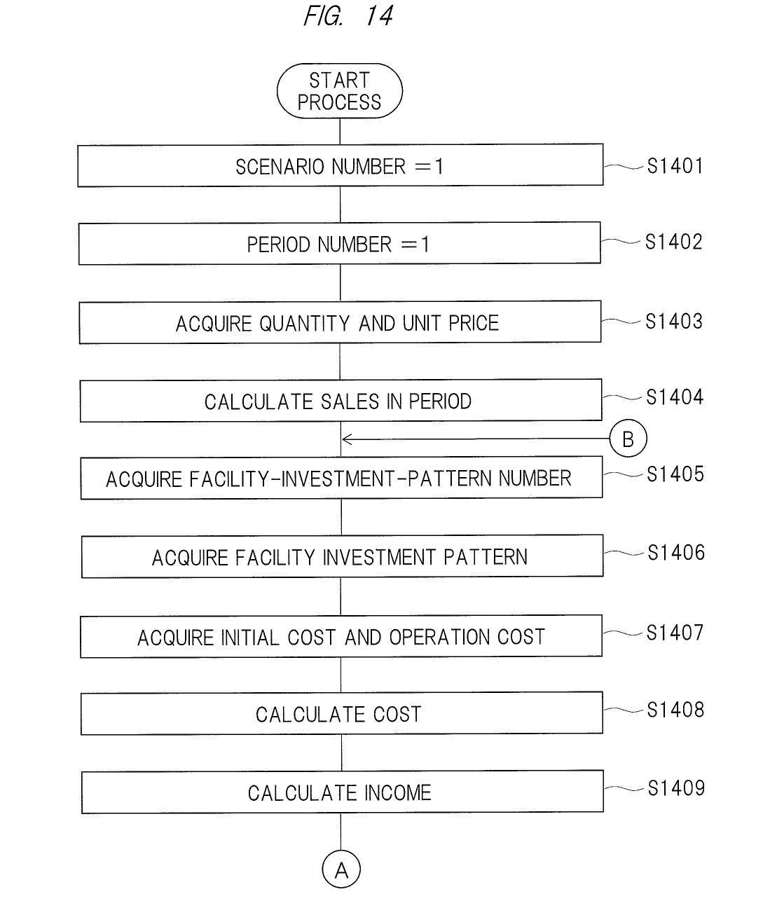

Then, in S1103, an income calculating process (described later, FIG. 14) is carried out to calculate the total income, etc. with respect to each of the facility investment scenarios generated in S1102. Then, the facility investment scenario corresponding to a selecting-input-received condition is acquired from the facility-investment-scenario storage unit, the periods and the facility investment patterns corresponding to the periods are displayed based on the acquired facility investment scenario, and the process is terminated.

<Facility-Investment-Pattern Generating Process>

FIG. 12 is a diagram showing a process flow of the facility-investment-pattern generating process of the present device.

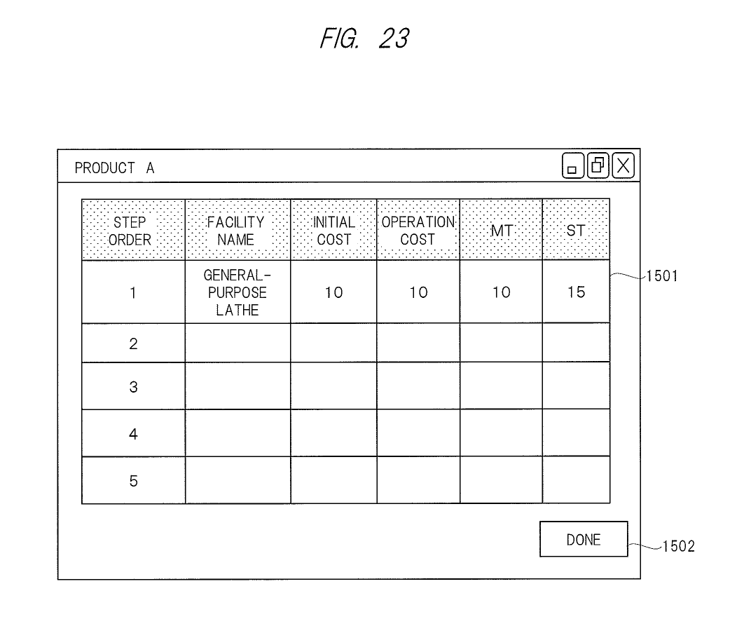

First, in S1201, the display unit 113 displays a facility-information input screen of FIG. 23. In the facility-information input screen, text boxes 1501 for receiving inputs of the facility information consisting of the data items of the [step order], [facility name], [initial cost], [operation cost], [MT], and [ST] are displayed. After all the inputs to the text boxes 1501 are received from a user, when an operation with respect to a “done” button 1502 is received, the facility information input to the text boxes 1501 is stored in the facility-information storage unit 1153.

Then, in S1202, the facility-investment-pattern generating unit 1113 acquires the corresponding step order from the step-information storage unit 1152 by using the product name, which is set in advance as an initial value, as a key. Moreover, the facility-investment-pattern generating unit 1113 acquires the corresponding [facility name] from the facility-information storage unit 1153 by using the acquired [step order] and [product] as keys.

Then, in S1203, the facility-investment-pattern generating unit 1113 generates a facility investment pattern based on the [step order] acquired in S1202 and the [facility name] corresponding to the [step order].

Then, in S1204, the facility-investment-pattern generating unit 1113 stores the facility investment pattern, which has been generated in S1203, in the facility-investment-pattern storage unit 1154.

Then, in S1205, the facility-investment-pattern generating unit 1113 calculates the number of producible products for each facility investment pattern generated in S1203. In order to calculate the number of producible products for each facility investment pattern, the facility-investment-pattern generating unit 1113 acquires corresponding MT or ST from the facility-information storage unit 1153 by using the respective [step orders] and [facility names], which are constituting the facility investment pattern, as keys. Then, the facility-investment-pattern generating unit 1113 calculates the number of producible products of each facility investment pattern based on the [step order], the MT or ST corresponding to the [step order], and the time by which the plant is operated during the period.

Then, in S1206, the facility-investment-pattern generating unit 1113 stores the production capacity result, in which the numbers of producible products calculated in S1205, the facility investment patterns, and the products are mutually associated, in the production-capacity-result storage unit 1156.

<Facility-Investment-Scenario Generating Process>

FIG. 13 is a diagram showing a process flow of the facility-investment-scenario generating process of the present device.

First, in S1301, the facility-investment-scenario generating unit 1117 sets “1” as the [period number] for carrying out search in the production-plan storage unit 1151.

Then, in S1302, the facility-investment-scenario generating unit 1117 carries out search in the production-plan storage unit 1151 by using the [period number] and the [product] as keys to acquire the corresponding [quantity].

Then, in S1303, the facility-investment-scenario generating unit 1117 acquires the [product] and all the [facility-investment-pattern numbers] by which the number of products equal to or more than the [quantity] acquired in S1302 can be produced from the production-capacity-result storage unit 1156 (for example, search is carried out by using the [quantity] as a key, thereby acquiring the [facility-investment-pattern numbers] corresponding to the [number of producible products] exceeding the [quantity]).

Then, in S1304, the facility-investment-scenario generating unit 1117 increments the [period number].

Then, in S1305, the facility-investment-scenario generating unit 1117 judges whether the [facility-investment-pattern numbers] corresponding to all the [period numbers] have been acquired or not. If the facility-investment-scenario generating unit 1117 judges that the [facility-investment-pattern numbers] corresponding to all the [period numbers] have not acquired (S1305—No), the process proceeds to S1302. On the other hand, if the facility-investment-scenario generating unit 1117 judges that the [facility-investment-pattern numbers] corresponding to all the [period numbers] have acquired (S1305—Yes), the process proceeds to S1306.

Then, in S1306, the facility-investment-scenario generating unit 1117 generates facility investment scenarios by mutually combining the [facility-investment-pattern numbers] of the respective [period numbers]. Then, the facility-investment-scenario generating unit 1117 allocates [scenario numbers] to the generated facility investment scenarios. Specifically, if: the [facility-investment-pattern numbers] of “1” serving as the [period number] are “1”, “2”, and “7”, the [facility-investment-pattern number] of “2” serving as the [period number] is “9”, the [facility-investment-pattern number] of “3” serving as the [period number] is “8”, and the [facility-investment-pattern numbers] of “4” serving as the [period number] are “30”, “70”, and “80”; in this case, the facility-investment-scenario generating unit 1117 generates scenarios “1 (period number=1), 9 (period number=2), 8 (period number=3), and 30 (period number=4)”, “1 (period number=1), 9 (period number=2), 8 (period number=3), and 70 (period number=4)”, “1 (period number=1), 9 (period number=2), 8 (period number=3), and 80 (period number=4)”, “2 (period number=1), 9 (period number=2), 8 (period number=3), and 30 (period number=4)”, “2 (period number=1), 9 (period number=2), 8 (period number=3), and 70 (period number=4)”, “2 (period number=1), 9 (period number=2), 8 (period number=3), and 80 (period number=4)”, “7 (period number=1), 9 (period number=2), 8 (period number=3), and 30 (period number=4)”, “7 (period number=1), 9 (period number=2), 8 (period number=3), and 70 (period number=4), and “7 (period number=1), 9 (period number=2), 8 (period number=3), and 80 (period number=4)” which are combinations of the [facility-investment-pattern numbers] of the respective [period numbers]. Then, the facility-investment-scenario generating unit 1117 allocates [scenario numbers] of “1” to “9” to the generated facility investment scenarios, respectively.

Then, in S1307, the facility-investment-scenario generating unit 1117 associates the generated facility investment scenarios with the [scenario numbers] and stores them in the facility-investment-scenario storage unit 1157.

<Income Calculating Process>

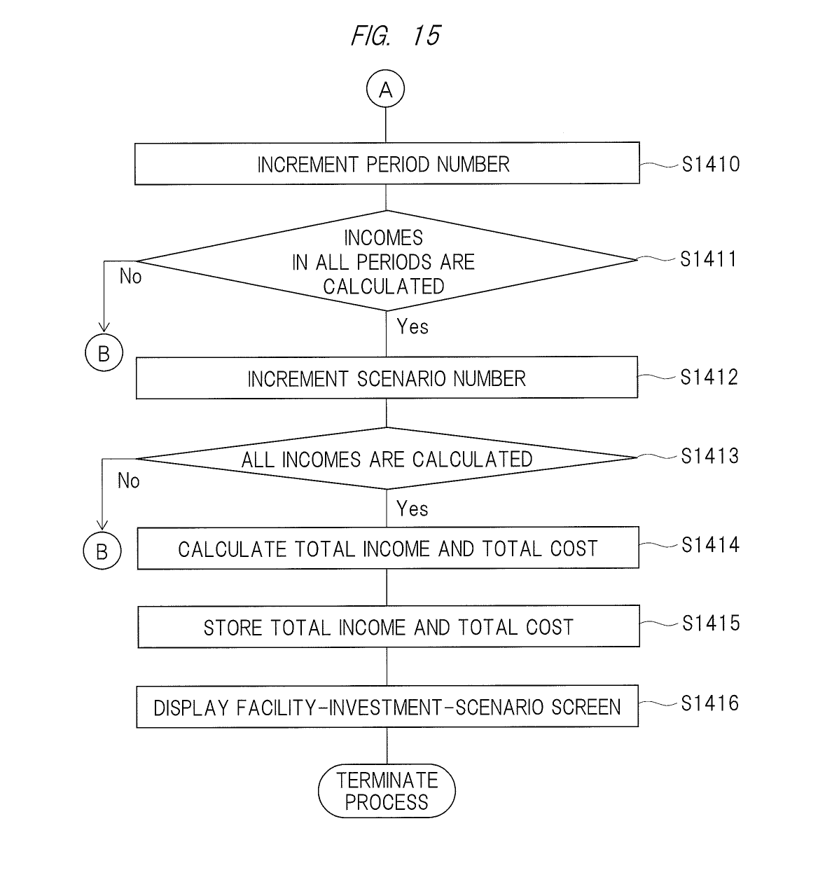

FIG. 14 and FIG. 15 are diagrams showing a process flow of the income calculating process of the present device. Note that FIG. 15 is a diagram subsequent to FIG. 14.

First, in S1401, the income-calculation processing unit 1114 sets “1” as the [scenario number] of the facility investment scenario corresponding to the [product] and acquired from the facility-investment-scenario storage unit 1157.

Then, in S1402, the income-calculation processing unit 1114 sets “1” as the [period number] for calculating an income.

then, in S1403 and S1404, the income-calculation processing unit 1114 calculates the sales in the period (this period corresponds to the [period number] acquired in S1402) corresponding to the facility investment scenario (this scenario corresponds to the [scenario number] acquired in S1401).

More specifically, in S1403, the income-calculation processing unit 1114 acquires the [quantity] and the [unit price] corresponding to the [period number] and the [product] from the production-plan storage unit 1151. In S1404, the income-calculation processing unit 1114 calculates the sales of the facility investment scenario in the corresponding period.

Then, in S1405 to S1408, the income-calculation processing unit 1114 calculates the cost in the period (this period corresponds to the [period number] acquired in S1402) corresponding to the facility investment scenario (this facility investment scenario corresponds to the [scenario number] acquired in S1401).

More specifically, in S1405, the income-calculation processing unit 1114 acquires the [facility-investment-pattern number] corresponding to the [scenario number] and the [period number] from the facility-investment-scenario storage unit 1157. Then, in S1406, the income-calculation processing unit 1114 acquires, from the facility-investment-pattern storage unit 1154, the facility investment pattern consisting of the data items such as [step order 1], [step order 2], [step order 3], [step order 4], and [step order 5] corresponding to the [product] and the [facility-investment-pattern number] acquired in S1405. Then, in S1407, the income-calculation processing unit 1114 acquires, from the facility-information storage unit 1153, the [initial cost] and the [operation cost] corresponding to the respective [facility names] operated in the respective steps of the [step order 1] to the [step order 5]. Finally, in S1408, the income-calculation processing unit 1114 calculates the cost in the period corresponding to the [period number] by adding all the acquired [initial cost] and [operation cost].

Then, in S1409, the income-calculation processing unit 1114 calculates the income in the corresponding period of the facility investment scenario by subtracting the cost calculated in S1408 from the sales calculated in S1404.

Then, in S1410, the income-calculation processing unit 1114 increments the [period number].

Then, in S1411, the income-calculation processing unit 1114 judges whether the incomes have been calculated or not for the periods corresponding to all the [period numbers] of the facility investment scenario. If the income-calculation processing unit 1114 judges that the incomes have not been calculated for the periods corresponding to all the [period numbers] (S1411—No), the process proceeds to S1405. On the other hand, if the income-calculation processing unit 1114 judges that the incomes have been calculated for the periods corresponding to all the [period numbers], the process proceeds to S1412.

Then, in S1412, the income-calculation processing unit 1114 increments the [scenario number].

Then, in S1413, the income-calculation processing unit 1114 judges whether the incomes have been calculated or not for the periods of the facility investment scenarios corresponding to all the [scenario numbers]. If the income-calculation processing unit 1114 judges that the incomes have not been calculated for the periods of the facility investment scenarios corresponding to all the [scenario numbers] (S1413—No), the process proceeds to S1405. On the other hand, if the income-calculation processing unit 1114 judges that the incomes have been calculated for the periods of the facility investment scenarios corresponding to all the [scenario numbers] (S1413—Yes), the process proceeds to S1414.

Then, in S1414, the income-calculation processing unit 1114 calculates the total income by totalizing the incomes calculated for the respective periods. Moreover, the income-calculation processing unit 1114 calculates total cost by totalizing the cost calculated for the respective periods.

Then, in S1415, the income-calculation processing unit 1114 associates the incomes in the periods, which are corresponding to the [product] and the [period number], with the [total income] and stores them in the facility-investment-scenario-dependent-income storage unit 1158. Moreover, the income-calculation processing unit 1114 associates the cost in the periods, which are corresponding to the [product], the [scenario number], and the [period number], with the [total cost] and stores them in the facility-investment-scenario-dependent-cost storage unit 1159.

Then, in S1416, the display unit 113 acquires the facility investment scenario corresponding to the set conditions from the facility-investment-scenario-dependent-income storage unit 1158 and displays the facility-investment-scenario display screen of FIG. 16.

Herein, the facility-investment-scenario display screen of FIG. 16 displayed by the display unit 113 displays a list box 1601 for selecting the condition for specifying the facility investment scenario to be displayed. When an input to the list box 1601 is received, the display unit 113 displays options such as “total income is the highest” and “surplus every year” arranged vertically. Then, when an input for selecting the option is received, the selection of the corresponding option is received.

Then, when the selection of the corresponding option is received, the display unit 113 carries out search in the facility-investment-scenario-dependent-income storage unit 1158 by the condition corresponding to the selection-received option and acquires the corresponding [scenario number]. Then, the display unit 113 acquires the facility investment patterns consisting of the data items such as the [step order 1], [step order 2], [step order 3], [step order 4], and [step order 5] corresponding to the [scenario number] from the facility-investment-pattern storage unit 1154. Then, the periods corresponding to the acquired [period numbers] and the names of the facilities operated in the steps corresponding to the [step order 1], [step order 2], [step order 3], [step order 4], and [step order 5] are displayed to be horizontally arranged. Moreover, in the order of the [period numbers], the periods and the names of the facilities operated in the steps corresponding to the periods are displayed to be vertically arranged. Furthermore, areas for displaying the names of the facilities newly added in the steps are displayed by a mode different from that of the areas for displaying the names of the facilities of the other steps.

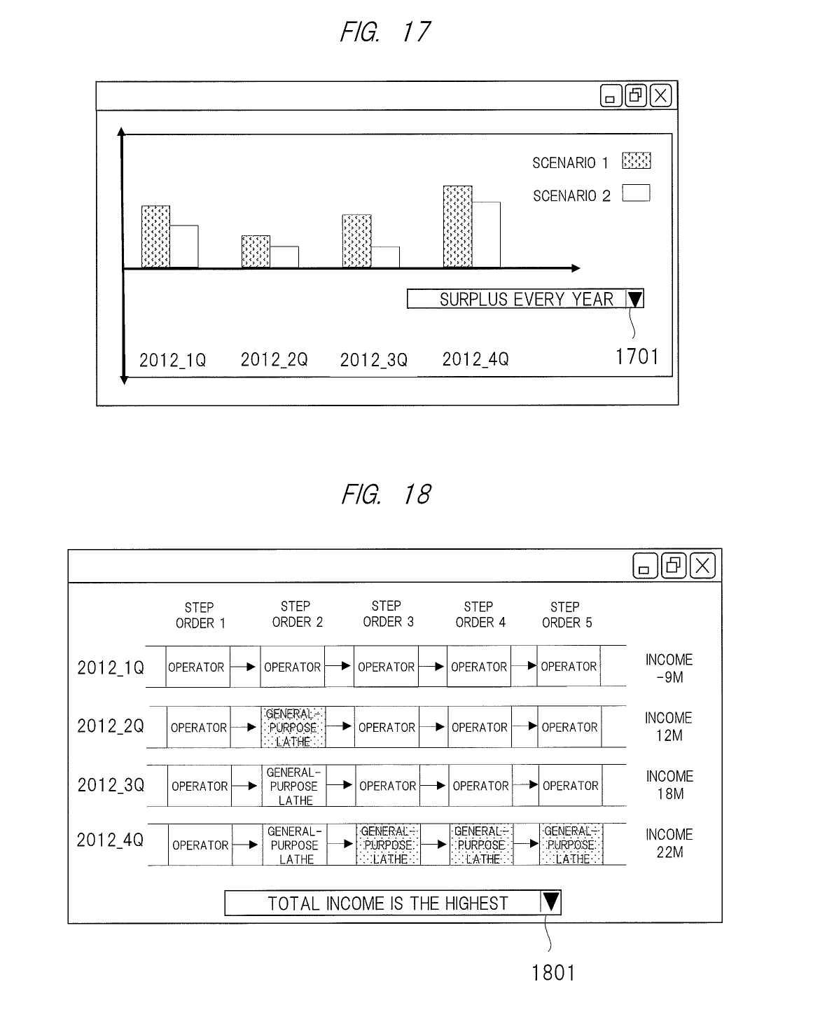

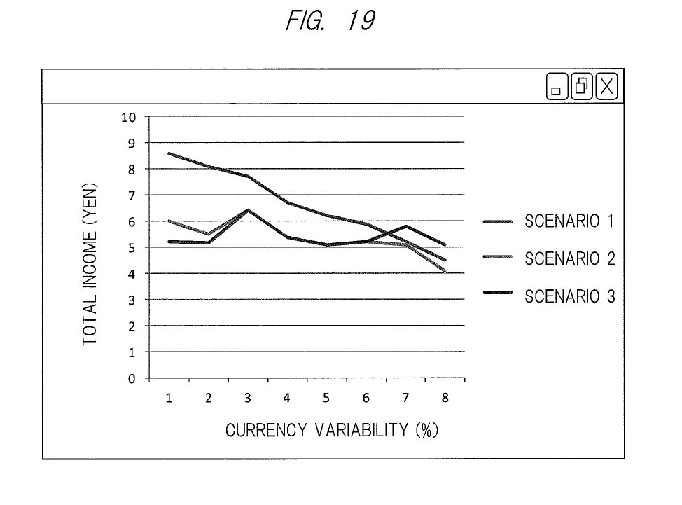

In S1416, instead of displaying the facility-investment-scenario display screen of FIG. 16, the display unit 113 may be configured to display any of a period-dependent income display screen (described later, FIG. 17), a facility-investment-scenario/income display screen (described later, FIG. 18), the currency-variability-rate/scenario display screen (described later, FIG. 19), the demand-increase-rate/scenario display screen (described later, FIG. 20), the demand-increase-rate/price display screen (described later, FIG. 21), and the entry screen (described later, FIG. 22).

Herein, in facility-investment-scenario providing device and method of the present invention, S1403 to S1409 correspond to an income-calculating step, and S1416 corresponds to a display step.

<Response Screen Example (1): Entry Screen>

FIG. 22 is a diagram showing an example of the entry screen displayed by the display unit 113. The entry screen displays items such as “facility-investment-scenario display”, “period-dependent income display”, “facility-investment-scenario/income display”, “currency-variability-rate/scenario display”, “demand-increase-rate/scenario display”, and “demand-increase-rate/price display”.

When an input of selecting an item from the entry screen is received, the display unit 113 displays the corresponding screen.

If an input selecting the item of “facility-investment-scenario display” is received, the display unit 113 displays the facility-investment-scenario display screen (described above, FIG. 16). If an input selecting the item of “period-dependent income display” is received, the display unit 113 displays the period-dependent income screen (described later, FIG. 17). If an input selecting the item of “facility-investment-scenario/income display” is received, the display unit 113 displays the facility-investment-scenario/income display screen (described later, FIG. 18). If an input selecting the item of “currency-variability-rate/scenario display” is received, the display unit 113 displays the currency-variability-rate/scenario display screen (described later, FIG. 19). If an input selecting the item of “demand-increase-rate/scenario display” is received, the display unit 113 displays the demand-increase-rate/scenario display screen (described later, FIG. 20). If an input selecting the item of “demand-increase-rate/price display” is received, the display unit 113 displays the demand-increase-rate/price display screen (described later, FIG. 21).

<Response Screen Example (2): Period-Dependent/Income Display Screen>

FIG. 17 is a diagram showing an example of the period-dependent income display screen displayed by the display unit 113. In the period-dependent income display screen, the display unit 113 displays a list box 1701 for selecting a condition for specifying the facility investment scenario(s) to be displayed. When an input to the list box 1701 is received, the display unit 113 displays options such as “total income is the highest” and “surplus every year” arranged vertically. Then, when an input for selecting the option is received, the selection of the corresponding option is received. If the selection of the corresponding option is received, the display unit 113 carries out search in the facility-investment-scenario-dependent-income storage unit 1158 by the condition corresponding to the selection-received option and acquires the incomes of the periods corresponding to the corresponding [scenario numbers] and [period numbers]. Then, the periods are displayed in the order of the [period numbers], and the incomes corresponding to the periods are displayed.

In the example of FIG. 17, an input for selecting the option “surplus every year” is received from the list box 1701. Then, the display unit 113 acquires, from the facility-investment-scenario-dependent-income storage unit 1158, the incomes in the periods corresponding to the [period numbers] of each of the records of “1” and “2” which are the [scenario numbers] with which the incomes in the periods corresponding to the [period numbers] are surpluses every year. Then, the periods are displayed in the order of the [period numbers], and the incomes in the periods of “1” which is the [scenario number] corresponding to the periods and the incomes in the periods of “2” which is the [scenario number] are displayed in a juxtaposed manner.

<Response Screen Example (3): Facility-Investment-Scenario-Income Display Screen>

FIG. 18 is a diagram showing an example of the facility-investment-scenario/income display screen displayed by the display unit 113. In the facility-investment-scenario/income display screen, the display unit 113 displays a list box 1801 for selecting a condition for specifying the facility investment scenario(s) to be displayed. When an input to the list box 1801 is received, the display unit 113 displays options such as “total income is the highest” and “surplus every year” vertically arranged. Then, when an input for selecting the option is received, the selection of the corresponding option is received. When the selection of the corresponding option is received, the display unit 113 carries out search in the facility-investment-scenario-dependent-income storage unit 1158 by the condition corresponding to the selection-received option and acquires the incomes in the periods corresponding to the corresponding [scenario number], [product], and [period numbers]. Then, the display unit 113 acquires the facility investment patterns consisting of the data items such as [step order 1], [step order 2], [step order 3], [step order 4], and [step order 5] corresponding to the [scenario number] from the facility-investment-pattern storage unit 1154. Then, the periods corresponding to the acquired [period numbers], the names of the facilities operated in the steps corresponding to the [step order 1], [step order 2], [step order 3], [step order 4], and [step order 5], and the incomes in the periods corresponding to the [period numbers] are displayed to be horizontally arranged. Moreover, in the order of the [period numbers], the periods and the names of the facilities operated in the steps corresponding to the periods are vertically arranged and displayed. Furthermore, the areas for displaying the names of the facilities newly added in the steps may be displayed by a mode different from that of the areas for displaying the names of the facilities of the other steps.

<Response Screen Example (4): Currency-Variability-Rate/Scenario Display Screen>

FIG. 19 is a diagram showing an example of the currency-variability-rate-scenario display screen displayed by the display unit 113. In the currency-variability-scenario display screen, the display unit 113 acquires the currency information received by the communication unit 114 from the external device 100 via the network 102. Then, the display unit 113 displays a graph showing the total incomes on a vertical axis and currency variability on a horizontal axis based on the acquired currency information and the [scenario numbers] and the [total incomes] acquired from the facility-investment-scenario-dependent-income storage unit 1158.

<Response Screen Example (5): Demand-Increase-Rate-Scenario Display Screen>

FIG. 20 is a diagram showing an example of the demand-increase-rate/scenario display screen displayed by the display unit 113. In the demand-increase-rate/scenario display screen, the display unit 113 acquires the demand increase rates received by the communication unit 114 from the external device 100 via the network 102. Then, the display unit 113 displays a graph showing the total incomes on a vertical axis and the demand increase rates on a horizontal axis based on the acquired demand increase rates and the [scenario numbers] and [total incomes] acquired from the facility-investment-scenario-dependent-income storage unit 1158.

<Response Screen Example (6): Demand-Increase-Rate/Price Display Screen>

FIG. 21 is a diagram showing an example of the demand-increase-rate/price display screen displayed by the display unit 113. In the demand-increase-rate/price display screen, the display unit 113 displays a graph showing the total cost on a vertical axis and the demand increase rate on a horizontal axis based on the [bases] and [cost coefficients] acquired from the production-base storage unit 1155 and the [total cost] of each of the [scenario numbers] acquired from the facility-investment-scenario-dependent-cost storage unit 1159.

### EFFECTS OF THE PRESENT EMBODIMENT

According to the facility-investment-scenario providing device 110 in the present embodiment explained above, the information showing when the production facility should be added or changed in order to obtain larger incomes can be provided by acquiring the facility investment scenario(s) corresponding to the selecting-input-received condition and displaying the periods and the facility investment patterns corresponding to the periods based on the acquired facility investment scenario(s).

Moreover, the income in the case in which an investment is made on the facility investment pattern can be calculated based on the production plan by calculating the income in each period based on the production plan of each period of the product and the cost of the facility investment pattern in each period.

Moreover, the information showing when the production facility should be added or changed in order to obtain the largest income can be provided by acquiring the facility investment scenario having the largest value of the total income and displaying the periods and the facility investment patterns corresponding to the periods based on the acquired facility investment scenario.

Moreover, when and which production facility should be added or changed in order to obtain a larger income can be visually understood by displaying the areas for displaying the names of the facilities newly added in the steps by the mode different from that of the areas for displaying the names of the facilities of the other steps.

Moreover, based on the acquired facility investment scenario, the periods and the incomes corresponding to the periods can be displayed.

Moreover, based on the acquired facility investment scenario, the periods, the facility investment patterns corresponding to the periods, and the incomes corresponding to the periods can be displayed.

Moreover, the graph showing the total incomes on the vertical axis and the currency variability on the horizontal axis can be displayed based on the currency information received from the external device and the total incomes acquired from the facility-investment-scenario-dependent-income storage unit.

Moreover, the graph showing total incomes on the vertical axis and the demand increase rates on the horizontal axis can be displayed based on the demand increase rates received from the external device and the total incomes acquired from the facility-investment-scenario-dependent-income storage unit.

Moreover, the graph showing the total cost on the vertical axis and the demand increase rates on the horizontal axis can be displayed based on the acquired bases, the cost coefficients, and the total cost.

In the foregoing, the invention made by the inventors of the present invention has been concretely described based on the embodiments. However, it is needless to say that the present invention is not limited to the foregoing embodiments and various modifications and alterations can be made within the scope of the present invention.

### EXPLANATION OF REFERENCE NUMERALS

100 External device
102 Network
113 Display unit
114 Communication unit
1113 Facility-investment-pattern generating unit
1114 Income-calculation processing unit
1117 Facility-investment-scenario generating unit
1151 Production-plan storage unit
1152 Step-information storage unit
1153 Facility-information storage unit
1154 Facility-investment-pattern storage unit
1155 Production-base storage unit
1156 Production-capacity-result storage unit
1157 Facility-investment-scenario storage unit
1158 Facility-investment-scenario-dependent-income storage unit
1159 Facility-investment-scenario-dependent-cost storage unit
1501 Text box
1601 List box
1602 List box
1603 List box

1. A facility-investment-scenario providing device comprising:
a facility-investment-scenario storage unit for storing a facility investment scenario having a facility investment pattern associated with each of periods obtained by dividing a total period for producing a product by every predetermined interval; and
a display unit for acquiring the facility investment scenario corresponding to a selecting-input-received condition from the facility-investment-scenario storage unit and displaying the facility investment pattern corresponding to each of the periods based on the acquired facility investment scenario.

2. The facility-investment-scenario providing device according to claim 1, further comprising:
an income-calculation processing unit for calculating an income in each of the periods based on a production plan of each of the periods of the product and cost of the facility investment pattern in each of the periods.

3. The facility-investment-scenario providing device according to claim 2,
wherein the display unit acquires, from a facility-investment-scenario-dependent-income storage unit, the facility investment scenario in which the value of a total income obtained by totalizing the income of the facility investment pattern in each of the periods constituting the facility investment scenario is largest.

4. The facility-investment-scenario providing device according to claim 1,
wherein the facility investment pattern has names of facilities of respective steps of producing the product; and
the display unit displays an area for displaying the name of the facility newly added in the step based on the acquired facility investment scenario, the area displayed by a mode different from that of an area for displaying the name of the facility of the other step.

5. The facility-investment-scenario providing device according to claim 2,
wherein the display unit displays the period and the income corresponding to the period based on the acquired facility investment scenario.

6. The facility-investment-scenario providing device according to claim 3,
wherein the display unit displays a graph showing the total income on a vertical axis and a currency variability rate on a horizontal axis based on currency information received from an external device and the total income acquired from the facility-investment-scenario-dependent-income storage unit.

7. The facility-investment-scenario providing device according to claim 3,
wherein the display unit displays a graph showing the total income on a vertical axis and a demand increase rate on a horizontal axis based on the demand increase rate received from an external device and the total income acquired from the facility-investment-scenario-dependent-income storage unit.

8. The facility-investment-scenario providing device according to claim 3, further comprising:
a production-base storage unit for storing a base and a cost coefficient so that the base is associated with the cost coefficient; and
a facility-investment-scenario-dependent-cost storage unit for storing the facility investment scenario and total cost in the total period of a case operated by the facility investment scenario so that the scenario is associated with the total cost,
wherein the display unit displays a graph showing the total cost on a vertical axis and a demand increase rate on a horizontal axis based on the base and the cost coefficient acquired from the production-base storage unit and the total cost acquired from the facility-investment-scenario-dependent-cost storage unit.

9. A facility-investment-scenario providing method comprising:
a display step of acquiring a facility investment scenario corresponding to a selecting-input-received condition by a display unit from a facility-investment-scenario storage unit and displaying a period and a facility investment pattern corresponding to the period by the display unit based on the acquired facility investment scenario.

10. The facility-investment-scenario providing method according to claim 9, further comprising:
an income calculating step of calculating an income of each of the periods by an income-calculation processing unit based on a production plan of each of the periods of the product acquired from a production-plan storage unit and cost of the facility investment pattern of each of the periods acquired from a facility-information storage unit.

11. The facility-investment-scenario providing method according to claim 10,
wherein, in the display step, the facility investment scenario in which the value of a total income obtained by totalizing the income of each of the periods is largest is acquired by the display unit from a facility-investment-scenario-dependent-income storage unit.

12. The facility-investment-scenario providing method according to claim 9,
wherein, in the display step, an area for displaying a name of a facility newly added in a step based on the acquired facility investment scenario is displayed by the display unit by a mode different from that of an area for displaying a name of a facility of another step.

13. The facility-investment-scenario providing method according to claim 10,
wherein, in the display step, the period and the income corresponding to the period are displayed by the display unit based on the acquired facility investment scenario.
